(19) United States
(12) Patent Application Publication
(10) Pub. No.: US 2022/0004934 A1
(43) Pub. Date: Jan. 6, 2022

(54) TRAINING DEVICE, ESTIMATION DEVICE, METHOD AND PROGRAM

(71) Applicant: NIPPON TELEGRAPH AND TELEPHONE CORPORATION, Tokyo (JP)

(72) Inventors: Yuki KURAUCHI, Tokyo (JP); Naoto ABE, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/293,728

(22) PCT Filed: Nov. 12, 2019
(86) PCT No.: PCT/JP2019/044331

§ 371 Date: May 13, 2021

(30) Foreign Application Priority Data
Nov. 16, 2018 (JP) 2018-215848

(51) Int. Cl. G06N 20/20; G06K 9/62

(52) U.S. Cl. CPC G06N 20/20; G06K 9/6257

(57) ABSTRACT

It is possible to learn a model for accurately estimating a label indicating the condition of data. A first model for determining, for each label, the likelihood of the label is learned, time-series likelihood data that is the likelihood of each label at each time is output for each piece of learning data, the time-series likelihood data for each piece of the learning data given a correct label is input, and machine learning is performed to learn a second model for outputting one of the labels based on a change in the likelihood of each label.

### TECHNICAL FIELD

The present invention relates to a learning device, an estimation device, a method, and a program, and particularly to a learning device, an estimation device, a method, and a program for estimating the state of a target.

### BACKGROUND ART

There have been studied techniques for using a sensor mounted on a moving body such as an automobile, a pedestrian, or a wheelchair moving on a road surface such as a sidewalk or a roadway to estimate the condition (step, slope, etc.) of the road surface on which the moving body moves (see, e.g., Non-Patent Literatures 1 and 2).

### CITATION LIST

### Non-Patent Literature

Non-Patent Literature 1: Akihiro Miyata, Iori Araki, Tongshun Wang, and Tenshi Suzuki, “A Study on Barrier Detection Using Sensor Data of Unimpaired Walkers”, IPSJ Journal (2018)
Non-Patent Literature 2: “Unevenness on Road Surface is Detected Using Acceleration Sensor of Smartphone Mounted on Expressway Bus, and Verification Test is Conducted”, [online], [searched on Nov. 6, 2018], Internet <URL: https://sgforum.impress.co.jp/news/3595>

### SUMMARY OF THE INVENTION

### Technical Problem

The estimation of the condition of a road surface as described above is often performed using a model built by machine learning using learning data. However, depending on the condition of the road surface, there is a problem that a desired estimation result cannot be obtained and the estimation accuracy is not sufficient.

The present invention has been made in view of the above circumstances, and aims at providing a learning device, a method, and a program capable of learning a model for accurately estimating a label indicating the condition of data. It also aims at providing an estimation device, a method, and a program capable of accurately estimating a label indicating the condition of data.

### Means for Solving the Problem

In order to achieve the above object, a learning device according to a first invention is configured to include: a first learning unit that receives, as input, a learning data set including learning data that is time-series data and is given one of a plurality of types of labels as a correct label at each time, performs predetermined machine learning to learn a first model for determining, for each of the labels, likelihood of the label, and outputs time-series likelihood data, which is likelihood of each of the labels at each time, for each piece of the learning data; and a second learning unit that receives, as input, the time-series likelihood data for each piece of the learning data given the correct label, and performs predetermined machine learning to learn a second model for outputting one of the labels based on a change in likelihood of each of the labels.

Further, an estimation device according to a second invention is configured to include: a first estimation unit that inputs time-series data to a learned first model for determining, for each of a plurality of types of labels, likelihood of the label, and estimates likelihood, for each of the labels, of the label at each time; and a second estimation unit that inputs the estimated likelihood, for each of the labels, of the label at each time to a learned second model for outputting one of the labels based on a change in likelihood of each label, and estimates one of the labels corresponding to likelihood of each of the labels at each time.

A learning method according to a third invention is characterized by including and executing: a step of a first learning unit receiving, as input, a learning data set including learning data that is time-series data and is given one of a plurality of types of labels as a correct label at each time, performing predetermined machine learning to learn a first model for determining, for each of the labels, likelihood of the label, and outputting time-series likelihood data, which is likelihood of each of the labels at each time, for each piece of the learning data; and a step of a second learning unit receiving, as input, the time-series likelihood data for each piece of the learning data given the correct label, and performing predetermined machine learning to learn a second model for outputting one of the labels based on a change in likelihood of each of the labels.

An estimation method according to a fourth invention is characterized by including and executing: a step of a first estimation unit inputting time-series data to a learned first model for determining, for each of a plurality of types of labels, likelihood of the label, and estimating likelihood, for each of the labels, of the label at each time; and a step of a second estimation unit inputting the estimated likelihood, for each of the labels, of the label at each time to a learned second model for outputting one of the labels based on a change in likelihood of each label, and estimating one of the labels corresponding to likelihood of each of the labels at each time.

A program according to a fifth invention is a program for causing a computer to function as each unit of the learning device according to the first invention.

A program according to a sixth invention is a program for causing a computer to function as each unit of the estimation device according to the second invention.

### Effects of the Invention

According to the learning device, the method, and the program of the present invention, it is possible to obtain an effect that a model for accurately estimating a label indicating the condition of data can be learned. Further, according to the estimation device, the method, and the program of the present invention, it is possible to obtain an effect that a label indicating the condition of data can be estimated accurately.

### BRIEF DESCRIPTION OF DRAWINGS

FIG. 1 is a diagram showing an example of a result of estimation of the condition of a road surface on which a moving body moves by conventional machine learning.

FIG. 2 is a block diagram showing a configuration of an estimation system including a learning device and an estimation device according to an embodiment of the present invention.

FIG. 3 is a flowchart showing a processing routine in the learning device according to the embodiment of the present invention.

FIG. 4 is a flowchart showing a processing routine in the estimation device according to the embodiment of the present invention.

### DETAILED DESCRIPTION OF THE INVENTION

An embodiment of the present invention will be described below in detail with reference to the drawings.

### Overview of Embodiment of the Present Invention

First, an overview of the embodiment of the present invention will be described. In the embodiment of the present invention, the estimation accuracy is improved by performing learning using the likelihood of each label obtained in time series to incorporate a change in likelihood in the time series of the label.

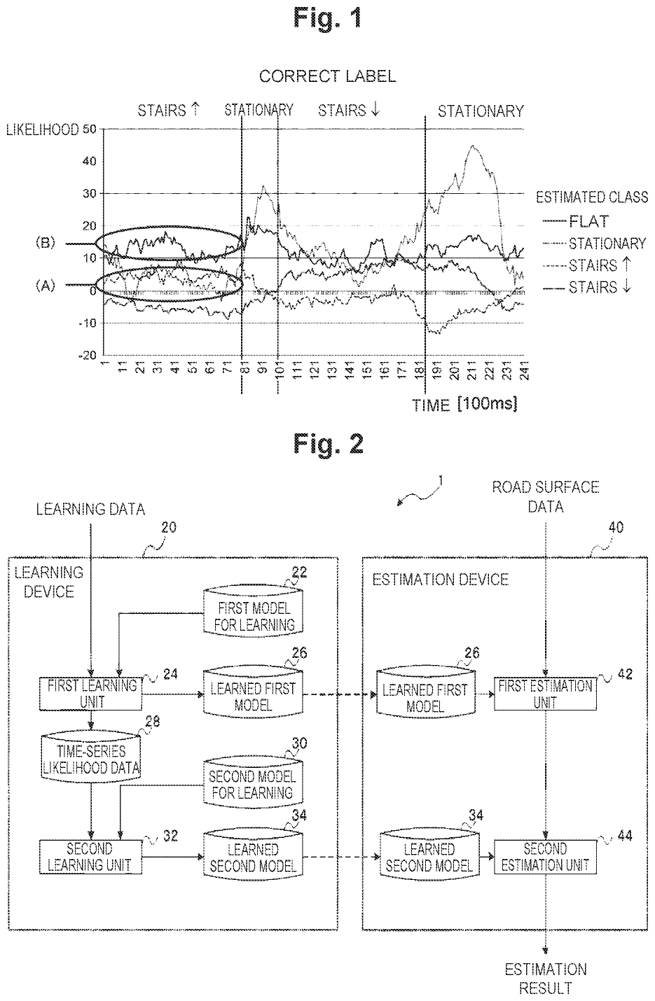

FIG. 1 shows an example of a result of estimation of the condition of a road surface on which a moving body moves by conventional machine learning. FIG. 1 shows a correct label and an estimation result of likelihood of each estimated class, and is a graph in which the vertical axis represents likelihood and the horizontal axis represents the time of time series. The time of time series is in units of 100 ms. Here, the unit of 100 ms is the unit time for shifting a batch at the time of learning, and the graph in FIG. 1 shows that there is a time transition of 100 ms per unit. Hereinafter, a “time” shown in the embodiment of the present invention represents a unit time of 100 ms. The estimated classes for the condition of the road surface on which the moving body moves are “flat” indicating a flat road, “stationary” indicating that the moving body is in a stationary state, “stairs ↑” indicating ascending stairs, and “stairs ↓” indicating descending stairs. The correct label is assigned to each time of the time series, but in the likelihood in the estimation result, the likelihood of the desired label may not always be the highest. For example, the correct label for times of 1-71 of the time series is “stairs ↑”, but the likelihood of the label “flat” shown in (B) is higher than the likelihood of the label “stairs ↑” shown in (A), resulting in a problem that the correct result cannot be obtained. Therefore, in the embodiment of the present invention, machine learning is performed in two stages so as to capture a change in likelihood in the case of viewing the entire time series of the labels. This makes it possible to estimate a desired label even if the learning data is biased.

The embodiment of the present invention will be described based on the above premises.

### Configuration According to Embodiment of the Present Invention

Next, a configuration according to the embodiment of the present invention will be described. As shown in FIG. 2, an estimation system 1 according to the embodiment of the present invention is configured to include a learning device 20 and an estimation device 40. Each of the learning device 20 and the estimation device 40 can be configured with a computer including a CPU, a RAM, and a ROM that stores a program for executing the processing of the operation described later and various data.

First, the learning device 20 will be described. A learning data set composed of learning data that is time-series data is input to the learning device 20. Road surface data detected in time series by a plurality of types of sensors that detect the state of the moving body that is the estimation target is used as the learning data. Further, the learning data is given one of a plurality of types of labels as the correct label at each time. The labels are types of the condition of the road surface on which the moving body moves, such as “flat”, “stationary”, “stairs ↑”, “stairs ↓”, etc. By subdividing the condition of the road surface, a label such as “2 cm step ↑” may be used. In this embodiment, it is assumed to learn a model for determining the likelihood of each label from input data obtained from road surface data by shifting a window having a width of 1500 ms in increments of 100 ms. The correct class is the condition of the road surface corresponding to the point of 750 ms, which is the center of the window. When learning and estimation are performed in real time, the window width may be shorter than 1500 ms. As the sensors, various sensors such as an acceleration sensor, a gyro sensor, a geomagnetic sensor, a gravity sensor, an atmospheric pressure sensor, and a tilt sensor can be used as appropriate according to the estimation target.

The learning device 20 includes a first learning unit 24 and a second learning unit 32. The first learning unit 24 uses a first model 22 for learning to build a learned first model 26. The first model 22 for learning is a model for determining, for each label, the likelihood of that label. The second learning unit 32 uses a second model 30 for learning to build a learned second model 34. Various machine learning models can be used as the first model 22 for learning and the second model 30 for learning, such as CNN (convolutional neural network), RNN (recurrent neural network), LSTM (long short-term memory), and SVM (support vector machine).

The first learning unit 24 receives the learning data set as input, performs machine learning to learn parameters of the first model 22 for learning, and builds the learned first model 26. Specifically, the parameters of the first model 22 for learning are learned from input data, which is obtained from the learning data by shifting the window having a width of 1500 ms in increments of 100 ms, and the correct label so that the likelihood of the correct label is highest. Further, the first learning unit 24 gives the correct label to the likelihood of each label at each time for each piece of the learning data that is obtained in the learning process, and stores it as time-series likelihood data 28. The correct label is given, for example, by giving the correct label corresponding to the time to each of the likelihoods of the labels of “flat”, “stationary”, “stairs ↑”, and “stairs ↓”. For example, in the case of the likelihood of each label for times of 1-71 shown in FIG. 1, “stairs ↑” is given as the correct label.

The second learning unit 32 receives the time-series likelihood data 28 as input, performs machine learning to learn parameters of the second model 30 for learning for outputting one of the labels based on a change in the likelihood of each label, and builds the learned second model 34. In the learning by the second learning unit 32, the parameters of the second model 30 for learning are learned using a change in likelihood. The second model 30 for learning outputs one of the labels using information on how much likelihood the likelihood of a label of interest at each time is as compared to the average likelihood of that label. The second learning unit 32 learns the second model 30 for learning using such a change in likelihood obtained from the time-series likelihood data 28 as the learning data.

In the machine learning by the first learning unit 24, it is sufficient to perform learning by setting, for example, the batch size to 64 to 512, the number of learning times to 500, the number of epochs (the number of times of iterating a learning unit in which the number of learning times is set to 1) to 50, etc. Also in the second learning unit 32, it is sufficient to perform machine learning by setting the batch size, the number of learning times, and the number of epochs in the same manner. Note that in the machine learning in the second learning unit 32, 1024, 2048, 4096, etc. may be used as a batch size different from that in the first learning unit 24. This enables learning such that the bias of the likelihood is reduced in consideration of a case where there is a correct label that is few in number in the learning data.

Next, the estimation device 40 will be described. Road surface data detected in time series by the sensors mounted on a moving body moving on a road surface is input to the estimation device 40. It is assumed that the state of the moving body at each time is detected in time series using the road surface data. The estimation device 40 estimates a label using the learned first model 26 for determining, for each of the plurality of types of labels, the likelihood of the label, and the learned second model 34 for outputting one of the labels based on a change in the likelihood of each label. The estimated label is “flat”, “stationary”, “stairs ↑”, “stairs ↓”, etc. used as the correct labels for the learning data in the learning device 20 described above.

The first estimation unit 42 inputs the road surface data, which is time-series data, to the learned first model 26, estimates the likelihood, for each label, of the label at each time, and outputs it to the second estimation unit 44. Specifically, the learned first model 26 is used to estimate the likelihood of each label for each piece of the input data obtained from the road surface data by shifting a window having a width of 1500 ms in increments of 100 ms, thereby determining the likelihood, for each label, of the label at each time.

The second estimation unit 44 inputs the likelihood, for each label, of the label at each time, which is estimated in the first estimation unit 42, to the learned second model 34, and estimates one of the labels corresponding to the likelihood of each label at each time.

### Operation According to Embodiment of the Present Invention

Next, the operation of the estimation system 1 according to the embodiment of the present invention will be described.

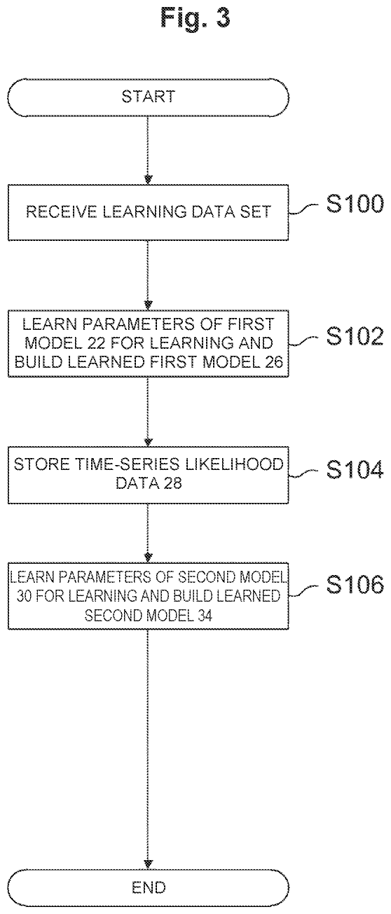

First, the operation of the learning device 20 will be described with reference to the flowchart in FIG. 3.

In step S100, the learning device 20 receives input of the learning data set composed of the learning data, which is time-series data. The learning data is the road surface data detected by the sensors in time series.

In step S102, the first learning unit 24 receives the learning data set as input, and performs machine learning to learn the parameters of the first model 22 for learning, and builds the learned first model 26.

In step S104, the first learning unit 24 gives the correct label to the likelihood of each label at each time for each piece of the learning data that is obtained in the learning process, and stores it as the time-series likelihood data 28.

In step S106, the second learning unit 32 receives the time-series likelihood data 28 as input, performs machine learning to learn the parameters of the second model 30 for learning for outputting one of the labels based on a change in the likelihood of each label, and builds the learned second model 34.

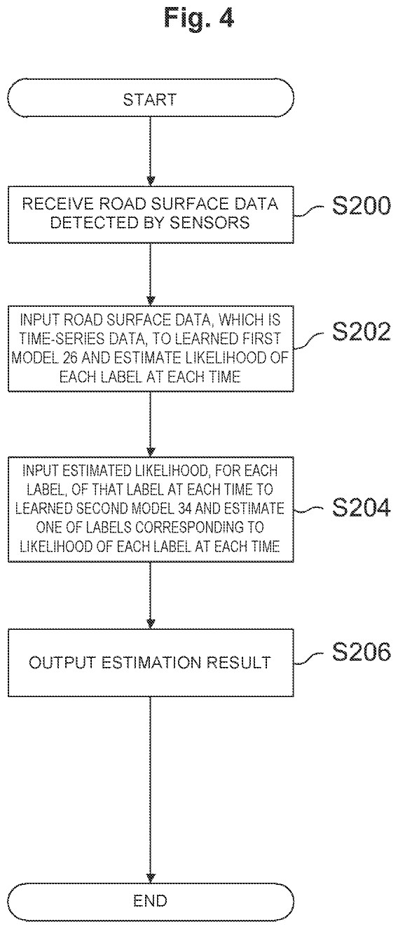

Next, the operation of the estimation device 40 will be described with reference to the flowchart in FIG. 4.

In step S200, the estimation device 40 receives input of the road surface data detected by the sensors in time series.

In step S202, the first estimation unit 42 inputs the road surface data, which is time-series data, to the learned first model 26, estimates the likelihood, for each label, of the label at each time, and outputs it to the second estimation unit 44.

In step S204, the second estimation unit 44 inputs the likelihood, for each label, of the label at each time, which is estimated in the first estimation unit 42, to the learned second model 34, and estimates one of the labels corresponding to the likelihood of each label at each time.

In step S206, the estimation device 40 outputs the label estimation result obtained in step S204.

As described above, in the estimation system 1 according to the embodiment of the present invention, the learning device 20 is used to learn the first model for determining, for each label, the likelihood of the label, and output the time-series likelihood data, which is the likelihood of each label at each time, for each piece of the learning data. Further, the time-series likelihood data for each piece of the learning data given the correct label is input, and machine learning is performed to learn the second model for outputting one of the labels based on a change in the likelihood of each label. This makes it possible to learn a model for accurately estimating a label indicating the condition of data.

Further, the estimation device 40 is used to input the time-series data to the learned first model for determining, for each of the plurality of types of labels, the likelihood of the label, and estimate the likelihood, for each label, of the label at each time. In addition, the estimated likelihood, for each label, of the label at each time is input to the learned second model for outputting one of the labels based on a change in the likelihood of each label, and one of the labels corresponding to the likelihood of each label at each time is estimated. This makes it possible to accurately estimate a label indicating the condition of data.

Further, the learning device 20 and the estimation device 40 can be implemented using a computer. Such a computer can be implemented by storing a program, in which the processing content for implementing each function of the learning device 20 and the estimation device 40 is written, in a storage unit of the computer in advance, and causing a CPU of the computer to read and execute this program.

Note that the present invention is not limited to the above-described embodiment, but various modifications and applications can be made without departing from the spirit of the present invention.

For example, although the case where the road surface data is used as input has been described as an example, it is not limited thereto, and the embodiment of the present invention can be applied to any data detected at each time of a time series.

### REFERENCE SIGNS LIST

1 Estimation system
20 Learning device
22 First model for learning
24 First learning unit
26 Learned first model
28 Time-series likelihood data
30 Second model for learning
32 Second learning unit
34 Learned second model
40 Estimation device
42 First estimation unit
44 Second estimation unit

1. A learning device comprising:
a first learner configured to:
receive, as input, a learning data set including learning data that is time-series data and is given one of a plurality of types of labels as a correct label at each time,
perform predetermined machine learning to learn a first model for determining, for each of the labels, likelihood of the label, and
output time-series likelihood data, which is likelihood of each of the labels at each time, for each piece of the learning data; and
a second learner configured to:
receive, as input, the time-series likelihood data for each piece of the learning data given the correct label, and
perform predetermined machine learning to learn a second model for outputting one of the labels based on a change in likelihood of each of the labels.

2. The learning device according to claim 1, wherein:
the learning data is road surface data detected in time series by a sensor that detects a state of a target, and
the label is a type of condition of a road surface on which the target moves.

3. The learning device according to claim 1, the device further comprising:
a first estimator configured to:
input time-series data to a learned first model for determining, for each of the plurality of types of labels, likelihood of the label, and
estimate likelihood, for each of the labels, of the label at each time; and a second estimator configured to:
input the estimated likelihood, for each of the labels, of the label at each time to a learned second model for outputting one of the labels based on the change in likelihood of each label, and
estimate one of the labels corresponding to likelihood of each of the labels at each time.

4. The learning device according to claim 3, wherein:
the time-series data is road surface data detected in time series by a sensor that detects a state of a target; and
the label is a type of condition of a road surface on which the target moves.

5. A learning method comprising:
receiving, by a first learner, as input, a learning data set including learning data that is time-series data and is given one of a plurality of types of labels as a correct label at each time, performing predetermined machine learning to learn a first model for determining, for each of the labels, likelihood of the label, and outputting time-series likelihood data, which is likelihood of each of the labels at each time, for each piece of the learning data; and
receiving, by a second learner, as input, the time-series likelihood data for each piece of the learning data given the correct label, and performing predetermined machine learning to learn a second model for outputting one of the labels based on a change in likelihood of each of the labels.

6. The learning method according to claim 5, the method further comprising:
inputting, by a first estimator, time-series data to a learned first model for determining, for each of the plurality of types of labels, likelihood of the label, and estimating likelihood, for each of the labels, of the label at each time; and
inputting, by a second estimator, the estimated likelihood, for each of the labels, of the label at each time to a learned second model for outputting one of the labels based on the change in likelihood of each label, and estimating one of the labels corresponding to likelihood of each of the labels at each time.

7. A computer-readable non-transitory recording medium storing a computer-executable program instructions that when executed by a processor cause a computer system to:
receive, by a first learner, as input, a learning data set including learning data that is time-series data and is given one of a plurality of types of labels as a correct label at each time, performing predetermined machine learning to learn a first model for determining, for each of the labels, likelihood of the label, and outputting time-series likelihood data, which is likelihood of each of the labels at each time, for each piece of the learning data; and
receive, by a second learner, as input, the time-series likelihood data for each piece of the learning data given the correct label, and performing predetermined machine learning to learn a second model for outputting one of the labels based on a change in likelihood of each of the labels.

8. The computer-readable non-transitory recording medium according to claim 7, the computer-executable program instructions when executed further causing the computer system to:
input, by a first estimator, time-series data to a learned first model for determining, for each of the plurality of types of labels, likelihood of the label, and estimating likelihood, for each of the labels, of the label at each time; and
input, by a second estimator, the estimated likelihood, for each of the labels, of the label at each time to a learned second model for outputting one of the labels based on the change in likelihood of each label, and estimating one of the labels corresponding to likelihood of each of the labels at each time.

9. The learning device according to claim 1, wherein the plurality of types of labels include at least one of: flat, stationary, ascending stairs, or descending stairs.

10. The learning device according to claim 2, wherein the sensor includes at least one of:
a gyro sensor,
a geomagnetic sensor,
a gravity sensor,
an atmospheric pressure sensor, or
a tilt sensor.

11. The learning device according to claim 2, wherein the sensor is a part of a moving body, and wherein the moving body includes one or more of: an automobile, a pedestrian, or a wheelchair on the road surface.

12. The learning method according to claim 5, the method further comprising:
inputting, by a first estimator, time-series data to a learned first model for determining, for each of the plurality of types of labels, likelihood of the label;
estimating, by the first estimator, likelihood, for each of the labels, of the label at each time;
inputting, by a second estimator, the estimated likelihood, for each of the labels, of the label at each time to a learned second model for outputting one of the labels based on the change in likelihood of each label; and
estimating, by the second estimator, one of the labels corresponding to likelihood of each of the labels at each time.

13. The learning method according to claim 5, wherein the plurality of types of labels include at least one of: flat, stationary, ascending stairs, or descending stairs.

14. The learning method according to claim 6, wherein the sensor includes at least one of:
a gyro sensor,
a geomagnetic sensor,
a gravity sensor,
an atmospheric pressure sensor, or
a tilt sensor.

15. The learning method according to claim 6, wherein the sensor is a part of a moving body, and
wherein the moving body includes one or more of: an automobile, a pedestrian, or a wheelchair on the road surface.

16. The learning method according to claim 12, wherein:
the time-series data is road surface data detected in time series by a sensor that detects a state of a target; and
the label is a type of condition of a road surface on which the target moves.

17. The computer-readable non-transitory recording medium according to claim 7, the computer-executable program instructions when executed further causing the computer system to:
input, by a first estimator, time-series data to a learned first model for determining, for each of the plurality of types of labels, likelihood of the label;
estimate, by the first estimator, likelihood, for each of the labels, of the label at each time;
input, by a second estimator, the estimated likelihood, for each of the labels, of the label at each time to a learned second model for outputting one of the labels based on the change in likelihood of each label; and
estimate, by the second estimator, one of the labels corresponding to likelihood of each of the labels at each time.

18. The computer-readable non-transitory recording medium according to claim 7, wherein the plurality of types of labels include at least one of: flat, stationary, ascending stairs, or descending stairs.

19. The computer-readable non-transitory recording medium according to claim 8, wherein the sensor includes at least one of:
a gyro sensor,
a geomagnetic sensor,
a gravity sensor,
an atmospheric pressure sensor, or
a tilt sensor, and
wherein the moving body includes one or more of: an automobile, a pedestrian, or a wheelchair on the road surface

20. The computer-readable non-transitory recording medium according to claim 17,
the time-series data is road surface data detected in time series by a sensor that detects a state of a target; and
the label is a type of condition of a road surface on which the target moves.
